(19) United States
(12) Patent Application Publication
(10) Pub. No.: US 2008/0276878 A1
(43) Pub. Date: Nov. 13, 2008

(54) RECREATIONAL DEVICE FOR PETS

(76) Inventor: Michael A. Ebert, St. Marys (CA)

Correspondence Address: Michael;Ebert, 17563 Gregory Dr., RR 3, St. Marys, ON, N4X 1C6, CA

(21) Appl. No.: 11/747,369

(22) Filed: May 11, 2007

(51) Int. Cl. A01K 15/02

(52) U.S. Cl. 119/706

(57) ABSTRACT

A recreational device for pets is provided comprising a pet recreational portion having an upper end and a lower end. At least one of the upper and lower ends includes a gripping foot shaped to permit placement of the device at multiple angles between first and second supporting surfaces.

### FIELD OF THE INVENTION

The present invention relates to devices for pets, and in particular, to a device for pet recreation that can be leaned up against a wall or other support.

### BACKGROUND OF THE INVENTION

A variety of devices intended for pet recreation exist including devices such as scratching posts for clawed pets, e.g. cats, which attempt to provide an attractive alternative to furniture, and other valuables within a home, which a pet can use for scratching and stretching, thereby preventing or minimizing damage to furniture.

One such scratching post is described by Cook in U.S. Pat. No. 4,177,763. This particular scratching post comprises a detachable post to permit convenient storage thereof from day to day, to render the scratching post more portable, and to minimize space usage and packaging on the retail side.

A mountable scratching device is also described in U.S. Pat. No. 6,715,447 to Haber. The device includes a clamping mechanism to allow it to be secured to an object such as a doorjamb. An obvious advantage of this device, thus, is that it does not take up floor space as a base to support the scratchable component of the device is not required.

Another device, offered by SmartCat, provides a scratching ramp having a scratchable surface which can support the cat. The device has angled ends which allow it to be leaned up against a wall or piece of furniture at a 45° angle.

It would be desirable to provide a novel recreational device for use by a pet, for scratching or other play, that improves upon those provided in the prior art.

### SUMMARY OF THE INVENTION

A recreational pet device is now provided designed to be leaned against a wall, furniture or other objects suitable to support the device, in a stable manner at multiple angles.

Thus, in one aspect of the present invention, there is provided a device for use by a pet, said device comprising a pet-recreational portion having an upper end and a lower end, at least one of said ends comprising a gripping foot shaped to permit placement of the device at multiple angles between first and second supporting surfaces.

Embodiments of the invention will become apparent in the description that follows, and in the drawings in which:

### BRIEF DESCRIPTION OF THE DRAWINGS

FIG. 1 is a perspective view of a device in accordance with an embodiment of the invention;

FIG. 2 is a side view of the placement of the device against a supporting surface at multiple angles (A;B;C);

FIG. 3 is a perspective view of other embodiments (A, B) of the invention;

FIG. 4 is a perspective view of a modular embodiment of the invention;

FIG. 5 is a perspective view of another modular embodiment;

FIG. 6 is a perspective view of another embodiment of the invention; and

### DETAILED DESCRIPTION OF THE INVENTION

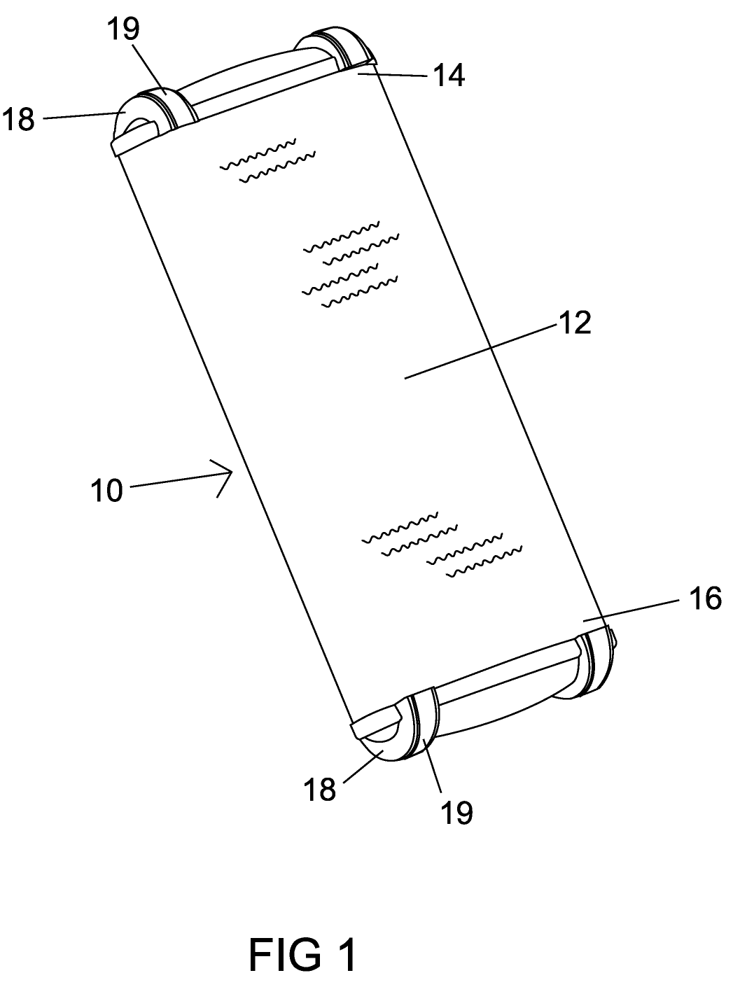

A device 10 is provided in one embodiment of the invention as shown in FIG. 1. The device 10 comprises a pet recreational portion 12 with an upper end 14 and a lower end 16.

The pet recreational portion 12, as shown, is a flattened cylinder in shape; however, the pet recreational portion 12 is not restricted with respect to shape and may comprise any suitable selected shape. In fact, the pet recreational portion 12 may take on various forms and configurations believed to be appealing to a pet and, thus, attract a pet. The pet recreational portion 12 may comprise: a surface suitable for scratching, pawing or clawing; a pet recreational portion such as a perch or the like; or a surface having a toy or other enticing decoy mounted thereon or suspended therefrom.

In this embodiment, the pet recreational portion 12 comprises a scratchable material suitable to satisfy the scratching and clawing behaviour of cats, and perhaps other clawed pets. Generally, the material is such that it will allow the pet to dig its claws into it. Examples of suitable materials include, but are not limited to, fabric, cloth, textile, carpet, durable padding, sisal, cardboard including corrugated cardboard, and other like materials. The pet recreational portion 12 may be made entirely of a selected scratchable material if it has sufficient rigidity to maintain a selected shape in view of the scratching and clawing. In this regard, an example of a suitable material is carpet tile, such as that manufactured by Bently, Bretlin, Interface Flooring, J&J Industries, Lees, Milliken, Mohawk, and Shaw.

Alternatively, the pet recreational portion 12 may comprise a frame or base structure covered, either on one side only or on both sides of the frame, with a material suitable for scratching. The frame or base structure may be formed of a single component that occupies the whole space of the recreational portion 12 or only a portion thereof, or may be formed of multiple components that form a frame, such as a pair of outer posts with or without cross-pieces in-between, onto which the scratchable material can be fastened. The frame or base structure may be made out of any material strong enough to support the scratchable material during use by a pet, such as wood, plastic, cardboard, rubber (e.g. silicone rubber) and metal. The scratchable material is fastened to the frame or base with any suitable fastening means (e.g. adhesive, screws, staples, etc.), or may be detachably fastened to the base or frame to allow removal of the scratchable material for washing, or to allow the scratchable material to be replaced with a new material when required. Such detachable fastening may be accomplished by numerous means including clips, adhesive material such as Velcro, or removable fasteners.

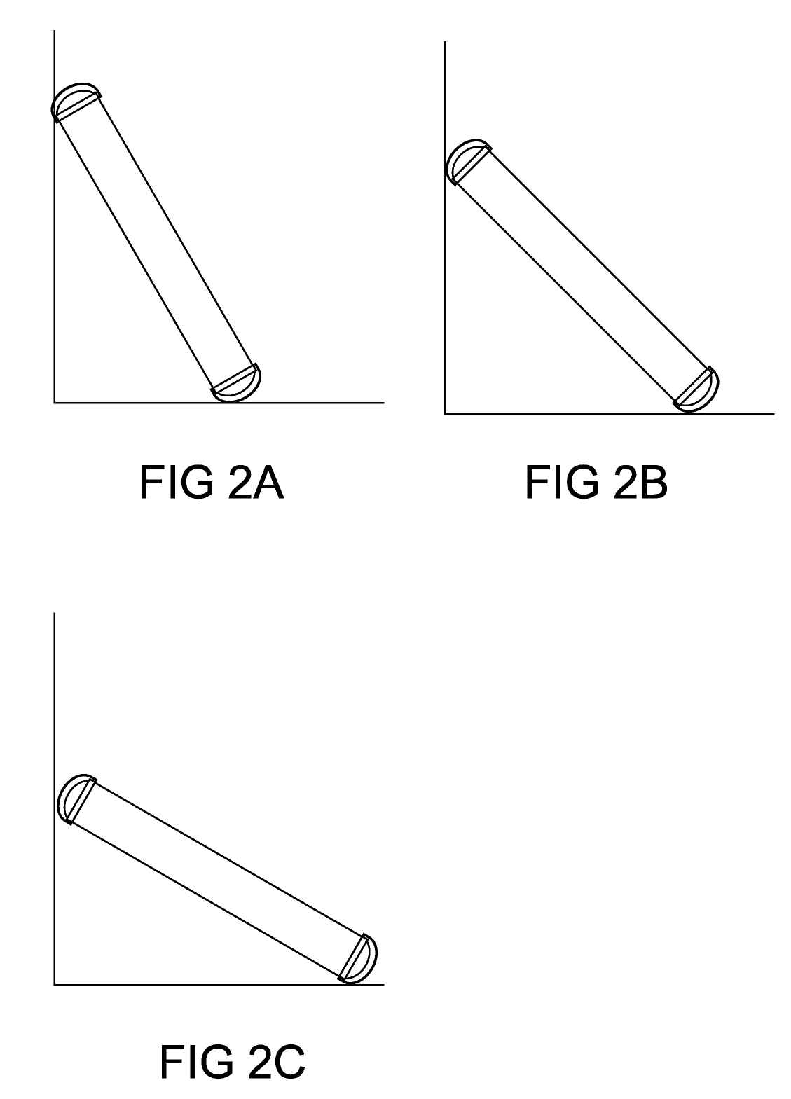

At least one gripping foot 18 is mounted onto at least one of the upper and lower ends 14, 16 of the recreational portion 12, or onto a frame 15. As shown, in one embodiment, two gripping feet may be mounted at each of the upper and lower ends (14, 16). Each of gripping feet 18a, 18b has a curved surface. The curved surface of each gripping foot 18 permits the device 10 to rest between first and second supporting surfaces such as an upright or essentially vertical surface (e.g. a wall) and an essentially horizontal surface (e.g. a floor or the ground) at various angles as shown in FIGS. 2A-C, including angles within the range of about 10° to about 80° to the upright surface. It will be appreciated, however, that the first and second supporting surfaces need not be vertical and horizontal, respectively, and may, for example, be angled surfaces slanted from vertical and/or horizontal, and may even comprise two substantially vertical surfaces or two substantially horizontal surfaces. The gripping feet 18 may be semi-circular in shape (or other portion of a circle), for example, but may also be a semi-oval shape (or other portion of an oval), a portion of a multi-angled polygonal or any other shape which allows stable placement of the device 20 at various angles.

The gripping feet 18 may include a strip of non-slip material or coating 19 along their curved edge to facilitate grip on the supporting surfaces and to minimize slippage of the device 10, particularly when a pet is mounting or using the device 10. Alternatively, the gripping feet may be made entirely of the non-slip material, or partially made of the non-slip material. Examples of suitable non-slip materials that may be used include rubber or a like material that has non-slip grip-like properties. The non-slip material 19 may have a smooth surface, or may have a rough or irregular surface or a surface comprising protrusions which increase its gripping function. The non-slip material 19 may be in the form of a suction cup which extends around the circumference of the curve on the gripping foot, which utilizes suction to stick to the supporting surface. The non-slip material 19 may also be an adhesive, such as an adhesive that does not leave a sticky residue behind.

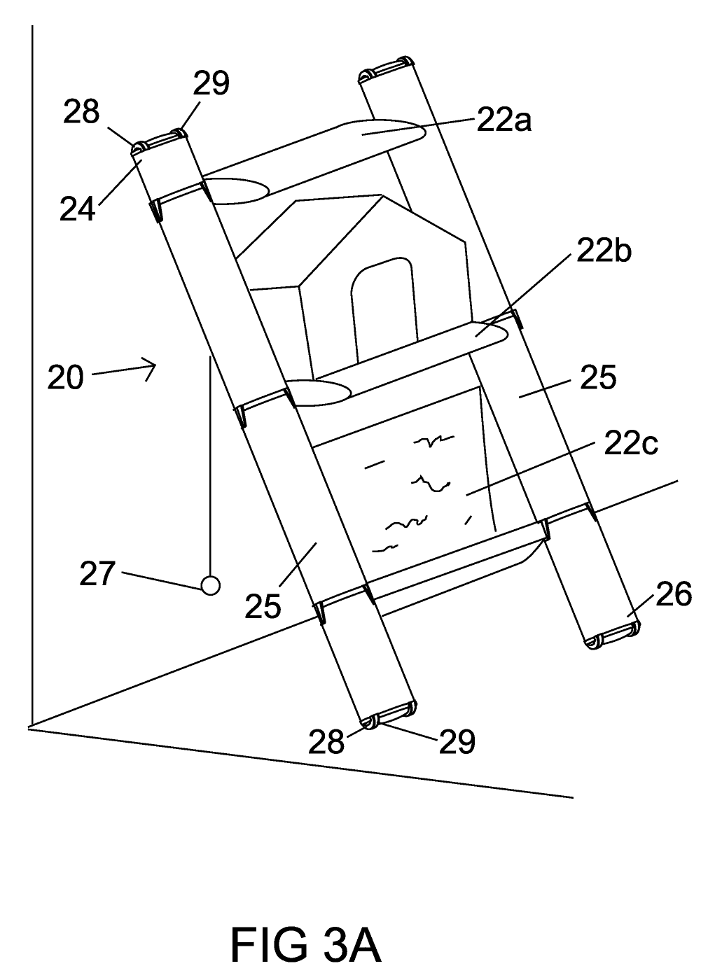

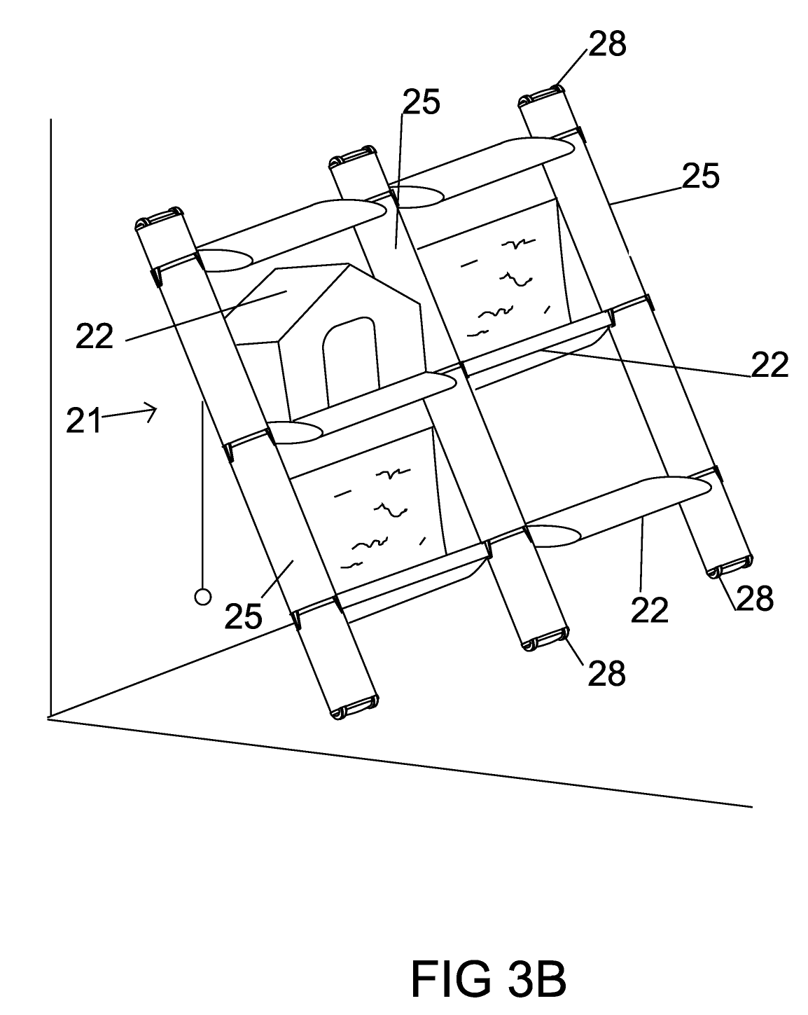

In another embodiment, a device 20 is provided as shown in FIG. 3A. The device 20 comprises multiple pet recreational portions 22 which are mounted for support on frame 25. In this case, the frame 25 comprises a pair of legs between which the pet recreational portions 22 are mounted. The pet recreational portions 22 are mounted and held in place between the frame legs using any suitable fastening means including screws, pegs, interlocking tabs and slots, etc. As illustrated, the pet recreational portions 22 are designed to be pet-supporting, providing an interesting, attractive resting place for a pet, such as a cat. While a pet recreational portion 22 may be a simple perch 22a, made out of an appropriate material for this purpose including wood, carpet tile, a carpet-covered frame (that may be made out of a variety of materials as set out above), the pet recreational portion 22 may include a pet house 22b or a pet hammock 22c. It will be understood that such a device may comprise any combination of pet-recreational portions 22, including pet-supporting portions as illustrated in FIG. 3 and scratchable portions or portions including a toy or other attraction.

The frame legs 25 each include a gripping foot 28 at both the upper end 24 and the lower end 26 thereof. As described above, the gripping foot 28 has a curved shape to allow the device 20 to be stably placed at various angles between first and second supporting surfaces such as an essentially vertical support (e.g. a wall) and an essentially horizontal support.(e.g. the floor). As set out above, each gripping foot 28 may include a strip of non-slip material or coating 29 along the curved edge of the gripping foot 28 to minimize slippage of the device 20, particularly when a pet is mounting or using the device 20.

The device 20 may additionally include attachments 27 hanging from or attached directly to the frame or pet recreational portions 22 to attract a pet, such as a catnip or a toy to play with such as a hanging ball or stuffed toy.

FIG. 3B illustrates another embodiment in which device 20 of FIG. 3A is laterally extended by the addition of a third frame leg 25 to form device 21. The third frame leg 25 includes gripping feet 28 at the upper 24 and lower 26 ends thereof as well as multiple pet recreational portions 22 mounted between adjacent frame legs 25 by suitable fastening means as described similar to device 20.

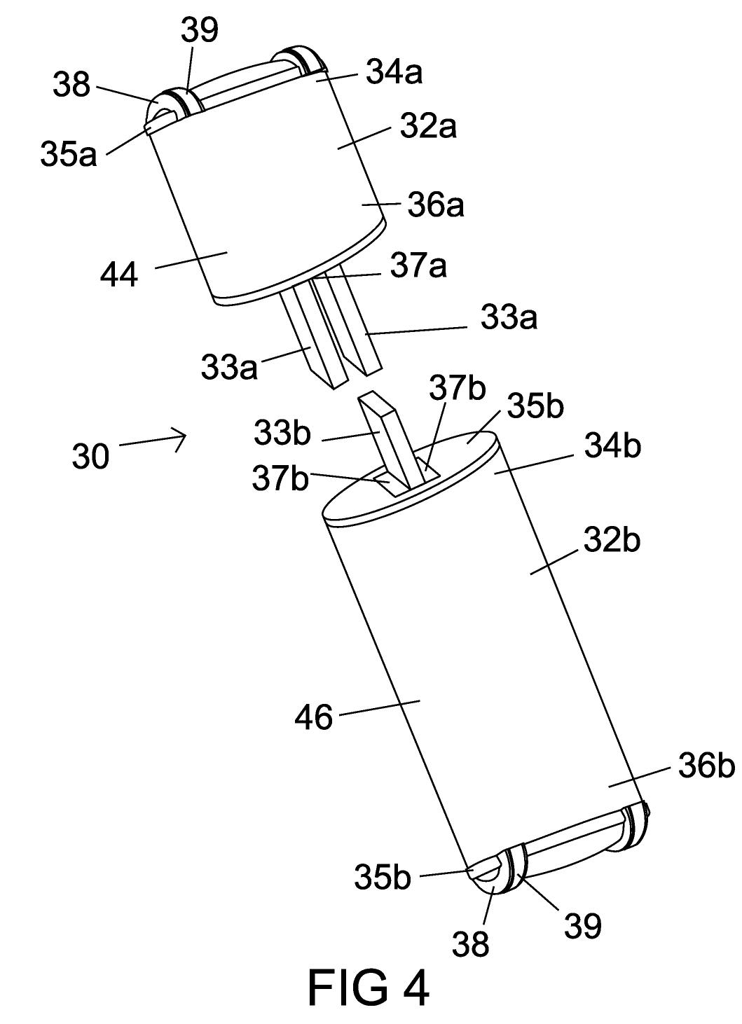

In a further embodiment, a modular device 30 is provided as shown in FIG. 4 to provide a device that can be disassembled to provide smaller pieces that are more portable and more readily stored. Thus, the device 30 includes a first (terminal) module 44 comprising an upper end 34a and a lower end 36a and a second (terminal) module 46 comprising an upper end 34b and a lower end 36b. Each of the first and second modules comprises a pet recreational portion 32a and 32b, respectively. The pet recreational portions 32a, 32b each include a scratchable surface which is wrapped around a base structure 35a and 35b, respectively.

To fit the first and second modules 44 and 46 together, the frame 35a of the first module 44 and the frame 35b of the second module 46 each comprise connecting means to join or fasten the two modules together. Although a variety of connecting means may be utilized to satisfy this function, in the embodiment shown, module 44 includes a pair of protrusions 33a extending from the frame 35a at the lower end 36a of the module 44 which fit into receiving apertures 37b in the frame 35b at the upper end 34a of the second module 46. A similar protrusion 33b extends from the frame 35b at the upper end 34b of the second module 46 and fits into a receiving aperture 37a located between protrusions 33a in the frame 35a at the lower end 36a of the first module 44.

The upper and lower ends 34a, 36b of the device 30 each include at least one gripping foot 38, and preferably a pair of gripping feet as shown. The gripping feet 38 may be part of the base frame 35a, 35b, or may be fastened to the frame 35a, 35b with suitable fastening means such as nails, screws, staples or adhesive such as glue. As previously described, each gripping foot has a curved or other shaped surface which permits stable placement of the device 30 at various angles between supporting surfaces such as substantially vertical and horizontal surfaces. Additionally, each gripping foot 38 may include a strip of non-slip material or coating 39 along the curved edge of the gripping foot 38.

In other embodiments, the modular device 30 may incorporate modules with alternate pet recreational portions or a module lacking a pet recreational portion. For example, the first module 44 may incorporate a perch or house as the pet recreational portion 32, as shown in FIG. 3, while the second module 46 remains with a scratchable surface, or incorporates a hammock. As will be appreciated, any combination of pet recreational portions on the first and second modules 44, 46 may exist in the modular device 30. It will also be appreciated that the connecting means used to join modules together will vary with the detail of each device and the selection of pet recreational portions forming each device. For example, the connecting means may be formed in frame legs located at either side of the device as illustrated in FIG. 3.

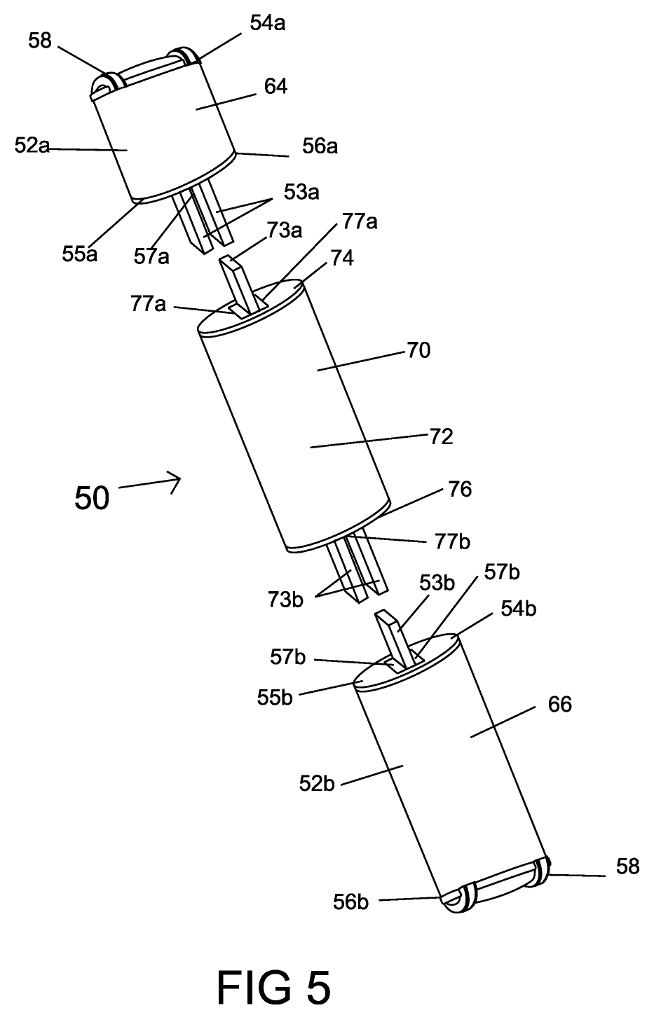

Modular devices in accordance with the invention may comprise more than two modules as in the device 50 shown in FIG. 5. This device 50 comprises first and second terminal modules 64 and 66 which correspond with modules 44 and 46, respectively, of device 30 as described, each including, respectively, upper and lower ends (54a, 56a; 54b, 56b), a pet recreational portion 52a, 52b, gripping feet 58, and modular connection means 33 and 37.

Device 50 additionally includes at least one central module 70 located between the first and second terminal modules 64 and 66. Similar to the first and second terminal modules 64, 66, the central module 70 comprises a pet recreational portion 72, which may be any pet recreational portion, e.g. a scratchable surface, perch, house, hammock, or any other suitable surface, and upper and lower ends 74, 76, respectively;

Both the upper and lower ends 74 and 76 of the central module 70 incorporate connecting means such that the upper end 74 of module 70 may be joined to the lower end 56a of the first module 64 and the lower end 76 of module 70 may be joined to the upper end 54b of the second module 66. The connecting means at the upper end 74 of central module 70 complements the connecting means at the lower end 56a of module 64, while the connecting means at the lower end 76 of module 70 complements the connecting means at the upper end 54b of module 66. Thus, as shown, extending from the frame 55a at the lower end 56a of module 64 is a pair of protrusions 53a having a receiving aperture 57a therebetween. Extending from the frame 75 at the upper end 74 of module 70 is a single protrusion 73a that fits into receiving aperture 57a. Receiving apertures 77a on either side of protrusion 73a receive protrusions 53a to join the lower end 56a of module 64 to the upper end 74 of module 70. Similarly, a pair of protrusions 73b extend from the frame 75 at the lower end 76 of module 70 with a receiving aperture 77b therebetween. Extending from the frame 55b at the upper end 54b of module 66 is a single protrusion 53b which fits into receiving aperture 77b. Receiving apertures 57b on either side of protrusion 53b receive protrusions 73b to join the upper end 54b of module 66 to the lower end 76 of central module 70.

Multiple central modules can be joined as described. Each central module comprises upper and lower ends with connecting means that complement the connecting means on the end of a module to which it is to be joined.

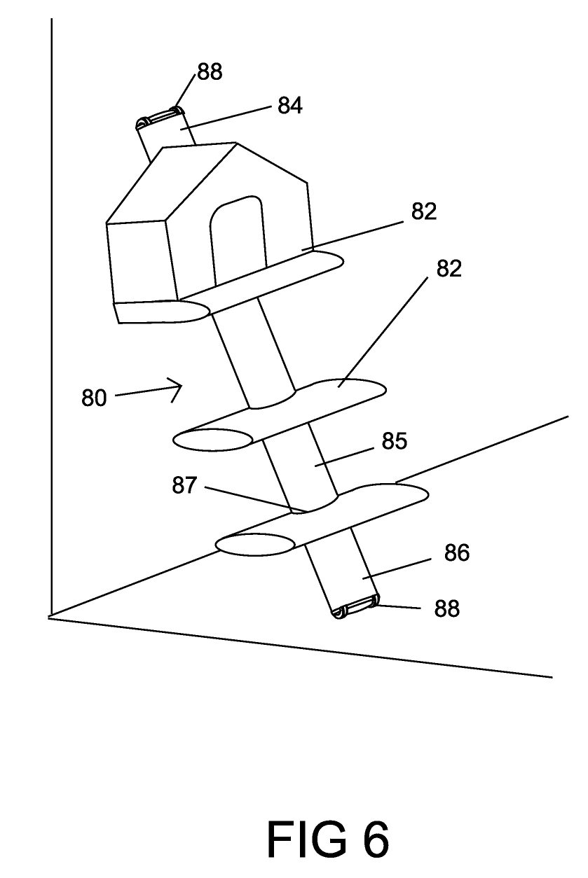

FIG. 6 illustrates another embodiment, device 80, comprising a single leg frame 85 which fits into one, or multiple (as shown), pet recreational portions 82. Each pet recreational portion 82 is formed with an aperture 87 therein which corresponds in shape with that of the frame 83 and is sized to permit the pet recreational portion 82 to be slid onto the frame 85 through the aperture 87 and snugly retained thereon.

The device 80 incorporates a gripping foot 88 at both the upper 84 and lower 86 ends thereof to retain the device 80 in a position, among multiple angled positions, between first and second supporting surfaces.

The foregoing description relates to certain embodiments of the invention; however, as one of skill in the art will appreciate, other embodiments may exist which fall within the scope of the appended claims.

We claim:

1. A device for use by a pet comprising a pet recreational portion having an upper end and a lower end, at least one of said ends comprising at least one gripping foot, said gripping foot being shaped to permit placement of the device at multiple angles between first and second supporting surfaces.

2. A device as defined in claim 1, comprising at least one gripping foot at the upper end of the device and at least one gripping foot at the lower end of the device.

3. A device as defined in claim 1, wherein each gripping foot has a curved shape.

4. A device as defined in claim 1, wherein each gripping foot comprises a circular shape in part.

5. A device as defined in claim 1, wherein each gripping foot comprises an oval shape in part.

6. A device as defined in claim 1, wherein each gripping foot comprises a polygonal shape in part.

7. A device as defined in claim 1, wherein the pet recreational portion comprises a scratchable surface.

8. A device as defined in claim 7, wherein the pet recreational portion comprises a material selected from the group consisting of carpet, cardboard, sisal and fabric.

9. A device as defined in claim 1, wherein each gripping feet comprises a non-slip surface.

10. A device as defined in claim 9, wherein the non-slip surface is rubber.

11. A device as defined in claim 1, wherein the pet recreational portion is a shelter.

12. A device as defined in claim 1, wherein the pet recreational portion is a perch.

13. A device as defined in claim 1, wherein the gripping foot at each end permits placement of the device at multiple angles between a first substantially vertical surface and a second substantially horizontal surface.

14. A device as defined in claim 1, wherein said upper end forms a first terminal module and said lower end forms a second terminal module, said first and second modules being detachable from one another.

15. A device as defined in claim 14, additionally comprising one or more central modules located between said first and second terminal modules, said central modules being detachable from the device.

16. A device for use by a pet comprising a pet recreational portion having an upper end and a lower end, each of said ends comprising at least one gripping foot that permits placement of the device at multiple angles between first and second supporting surfaces.

17. A device as defined in claim 1, wherein each gripping foot comprises a shape selected from the group consisting of a circular shape in part, an oval shape in part and a polygonal shape in part.

18. A device as defined in claim 16, wherein each gripping foot comprises a shape selected from the group consisting of a circular shape in part, an oval shape in part and a polygonal shape in part.

19. A device as defined in claim 16, wherein at least one of said gripping feet comprises a non-slip surface.
